(19) United States
(12) Patent Application Publication
(10) Pub. No.: US 2009/0291576 A1
(43) Pub. Date: Nov. 26, 2009

(54) CONNECTOR

(75) Inventors: David JOHANSSON, Malmo (SE); Henrik BORJESON, Lund (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/125,960

(22) Filed: May 23, 2008

(51) Int. Cl. H01R 13/62

(52) U.S. Cl. 439/152; 439/344

(57) ABSTRACT

In an embodiment, a connector having at least one locking element configured to be movable between a first position retracted inside an elongate member of the connected and a second position protruding from the circumferential surface of said elongate member is provided.

### FIELD OF THE INVENTION

The present invention relates to connectors.

### BACKGROUND OF THE INVENTION

Connectors are used to electrically connect two devices with each other. One type of connectors are audio connectors like so-called TS (tip sleeve), TRS (tip ring sleeve) or TRRS (tip ring ring sleeve) connectors which are for example used to connect headphones or loudspeakers to audio equipment, for example portable audio equipment, cell phones, personal computers and the like. Commonly used audio connectors include 6.35 mm, 3.5 mm or 2.5 mm audio connectors. Male audio connectors have a generally elongate form where areas of the circumference are insulated from each other to provide a plurality of contacts. For example, the tip of such an elongate connector may be insulated from one or more areas (ring areas) of the circumferential surface adjacent to the clip. Depending on whether such a connector is used for mono or stereo audio signal transmission, different numbers of contact areas insulated from each other may be used. Additional conducting areas may be used for additional signals like video signals.

Such connectors besides the above-described male version (also referred to as plug) also have a female version (also referred to as socket), the male connector being inserted into the female connector for establishing electrical contact. However, there is the danger that the male connector is loosened, for example due to shocks, such that the electrical connection is interrupted.

Therefore, there is a general need for male connectors which may be secured in corresponding female connectors.

### SUMMARY OF THE INVENTION

In an embodiment, a connector is provided, comprising:

an elongate member, that elongate member comprising at least two electrically conducting areas on its outer surface, said two electrically conducting areas being insulated from each other,

at least one locking element configured to be moveable between a first position retracted into said elongate member and a second position protruding from the circumferential surface of the elongate member, and

an ejection mechanism configured to move said at least one locking element from said first position to said second position.

In an embodiment, the connector may be an audio connector, for example a 2.5 mm or a 3.5 mm audio connector.

The at least one locking element may comprise at least one locking ball.

In an embodiment, the ejection mechanism comprises an ejection element having a slanted surface, said slanted surface being in contact with the at least one locking element and being movable to move said at least one locking element from said first position to said second position. In an embodiment, the ejection element is coupled with a resilient element like a spring, the resilient element biasing said ejection element to a position corresponding to said second position of said at least one locking element. A button may be provided coupled with said ejection element for pushing the ejection element against the biasing force of the resilient element.

The at least one locking element may be coupled with a resilient element like a spring to bias said at least one locking element to said first position.

The connector may comprise a ridge arranged at a side of said connector.

The at least one locking element may be electrically conducting, said at least one locking element being electrically isolated from said at least two electrically conducting areas. At least two locking elements may be provided, each of said at least two locking elements being conducting and being electrically isolated from each other to form separate electrical contact areas.

According to another embodiment, a connector is provided comprising:

an elongate hole,

at least two electrical contacts configured to contact two different portions of a further connector insertable into said elongate hole, and

at least one circumferential groove portion in a sidewall of said elongate hole.

The at least one circumferential groove portion may be electrically conducting and isolated from said contacts.

The above features of various embodiments may be combined with each other unless specifically noted to the contrary.

### BRIEF DESCRIPTION OF THE DRAWINGS

FIG. 1 shows a cross-sectional view of embodiments of a male and a female connector according to the present invention with locking elements in a locking position,

FIG. 2 shows the embodiment of FIG. 1 with locking elements in a retracted position,

FIG. 3 shows a cross-sectional view of other embodiments of a male and a female connector according to the invention,

FIG. 4 shows a cross-sectional view of further embodiments of a male and a female connector according to the present invention,

FIG. 5 shows a partial cross sectional view of another embodiment of a locking element according to the present invention, and

FIG. 6 shows a cross sectional view of a further embodiment of a locking element according to the present invention.

### DETAILED DESCRIPTION OF THE INVENTION

In the following, embodiments of the present invention will be described with reference to the accompanying drawings. The embodiments are taken to be as examples only and are not to be construed as limiting the scope of the present invention. It should be noted that in the drawings, the elements are not necessarily to scale with each other, but have been depicted in a manner to convey an understanding of the features of the embodiments to a person skilled in the art. Any directional terminology in the following description like “left”, “right”, “up” or “down” is to be understood as being a reference to the way the embodiments are depicted in the drawings only and are not to be construed as limiting the present application to the directional arrangement shown. In particular, it is to be understood that embodiments of the present invention may be oriented in any suitable way.

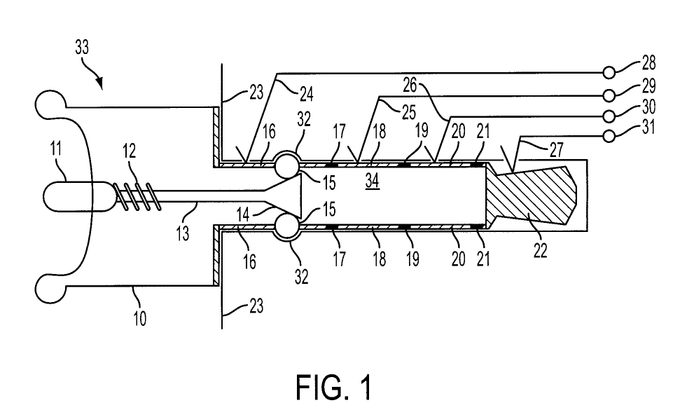

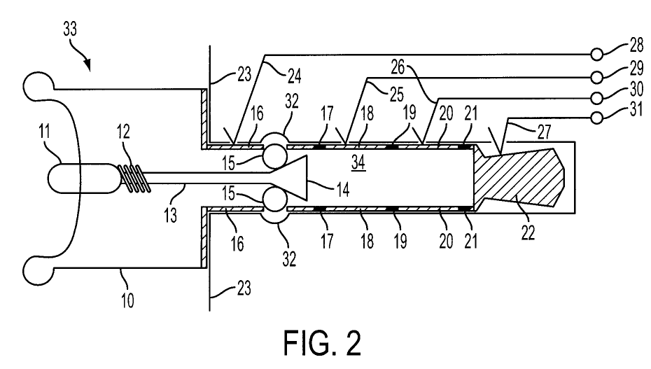

In FIGS. 1 and 2, an embodiment of a male connector 33 and an embodiment of a corresponding female connector 23 according to the present invention is shown in cross section. The embodiment of the male connector 33 of FIGS. 1 and 2 has the form of 3.5 mm audio connector in a so-called TRRS arrangement, i.e. a tip area 22, a first ring area 20, a second ring area 18 and a sleeve area 16 of an elongate member 34 of the male connector are electrically insulated from each other by insulation rings 17, 19 and 21 to provide separate electrical contacts. The sleeve portion 16 ends in a connector head 10.

The male connector 33 as shown in FIGS. 1 and 2 is inserted in the corresponding female connector 23 which essentially comprises an elongate hole approximately matching the shape of the elongate member of the elongate member 34 protruding from head 10 which ends in tip 22 as shown in FIG. 1. In the embodiment of FIGS. 1 and 2, the sidewall of the elongate hole of female connector 23 has openings through which contact 24, 25, 26 and 27 protrude to contact sleeve area 16, first ring area 18, second ring area 20 and tip area 22, respectively, when the male connector 33 is inserted in the female connector 23 as shown. Contacts 24, 25, 26 and 27 may for example be made of resilient metal to establish contact with some pressure on areas 16, 18, 20 and 21, respectively. In the inside of the male connector 33, wires (not shown) or other electrical conductors may be connected to areas 16, 18, 20 and 22 to tap signals from these portions or to supply signals to these portions. Likewise, contacts 24, 25, 26 and 27 may be tapped or supplied at contacting portions 28, 29, 30 and 31, respectively.

In order to be able to securely lock male connector 33 in female connector 23, a locking mechanism is provided. In male connector 33, a locking mechanism comprises a button 11 connected via a rod 13 with an end portion 14, and a spring 12 which, in the embodiment of FIGS. 1 and 2, biases the button 11 together with rod 13 and end portion 14 to the left, i.e. to the position shown in FIG. 1. Furthermore, the locking mechanism in male connector 33 comprises locking balls 15, serving as locking elements. In the locking mechanism, button 11, spring 12, rod 13 and end portion 14 form an ejection mechanism for moving locking balls 15 to a position where they protrude from elongate member 34 in a circumferential direction. In the female connector 23, the locking mechanism comprises a circumferential groove 32 at a position corresponding to the position of locking balls 15.

In the embodiment of FIGS. 1 and 2, end portion 14 has a frustro-conical shape with slanted side surfaces such that the diameter of end portion 14 increases from left to right in FIG. 1. In the position shown in FIG. 1 as biased by spring 12, end portion 14 pushes locking balls 15 to protrude from the elongate member 34 of male connector 33 into circumferential groove 32, thus locking male connector 33 in female connector 23. In order to unlock male connector 33, for example in order to take male connector 33 out of female connector 23, as shown in FIG. 2, button 11 is pressed againg the biasing force of spring 12 thus compressing spring 12 and moving button 11, rod 13 and end portion 14 to the right. In this position as shown in FIG. 2, locking balls 15 may retract into elongate member 34. In the embodiment of FIGS. 1 and 2, through the rounded form of the circumferential groove 32 and locking balls 15, in case locking ball 15 do not retract by themselves into elongate member 34 when button 11 is pressed, when male connector 33 is pulled out of female connector 23 locking balls 15 are pushed into elongate member 34 by circumferential groove 32.

In the embodiment of FIGS. 1 and 2, locking balls 15 may be made of any suitable material including conducting materials like metals and non-conducting materials like some plastic materials. Likewise, end portion 14, rod 13 and button 11 may be made of any suitable material. In case balls 15 are made of a conducting material, they may form part of the contacting area of sleeve portion 16. In such an embodiment, the locking mechanism through the firm contact between balls 15 and groove 32 may decrease the contact resistance between sleeve portion 16 and the corresponding contact on the female connector side by making groove 32 conducting and part of this contact. In a different embodiment, balls 15 may be arranged in a different portion, e.g. one of the ring portions, to decrease a corresponding contact resistance.

In the cross sectional view of FIGS. 1 and 2, two locking balls 15 are shown. The number of locking balls in embodiments of the invention is not restricted to two, but only one locking ball may be used, or more than two locking balls may be used.

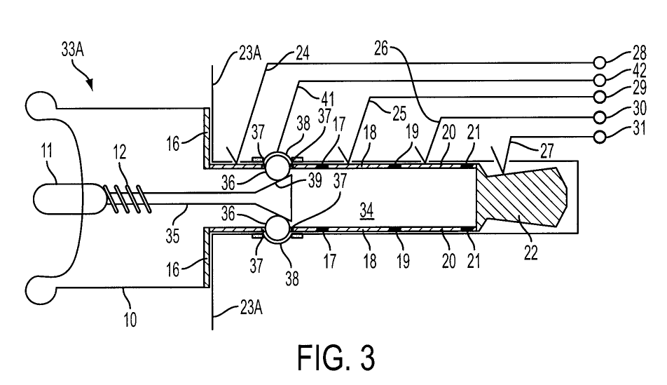

Turning now to FIG. 3, a further embodiment of a male connector 33A and a further embodiment of a corresponding female connector 23A according to the present invention will be described. The embodiments shown in FIG. 3 are based on the embodiments of FIGS. 1 and 2, and like elements bear the same reference numerals. Therefore, in the following only the additions and modifications of male connector 33A compared with male connector 33 of FIGS. 1 and 2 and of female connector 23A compared with female connector 23 of FIGS. 1 and 2 will be described.

In female connector 33A, locking balls 36 are provided which are conducting locking balls. Locking balls 36 in the embodiment of FIG. 3 are electrically insulated from elongate member 34 by insulating portions 37 surrounding the openings in elongate member 34 through which locking balls 36 protrude. Furthermore, a locking mechanism of the embodiment of FIG. 3 comprises a button 11 connected via a rod 35 with an end portion 39. Rod 35 and end portion 39 may have the same geometrical shape as rod 13 and end portion 14 of FIGS. 1 and 2. In the embodiment of FIG. 3, end portion 39 is electrically conducting such that in the locked position shown in FIG. 3 corresponding to the position of end portion 14 of FIG. 1 electrical contact between locking balls 36 and end portion 39 is established. Rod 35 also may be electrically conducting. Locking balls 16 together with conducting end portion 39 serve as a further separate contact. Correspondingly, circumferential groove 38 of female connector 23A in the embodiment of FIG. 3 is conducting and may be insulated from the rest of female connector 23A. Circumferential groove 38 is connected with a further contact portion 42 via an electrical connection 41.

In male connector 33A, a further wire or other electrical connection (not shown) may be coupled with electrically conducting end portion 39 or electrically conducting rod 35. In a different embodiment, end portion 39 and rod 35 need not be conducting, and wires are directly coupled with locking balls 36.

Therefore, in the embodiment of FIG. 3 via locking balls 36 and circumferential groove 38 a further contact apart from areas 16, 18, 20, 22 and the corresponding contacts 24, 25, 26 and 27 is provided.

Otherwise, the functioning of the embodiment of FIG. 3 and the corresponding locking mechanism is the same as already described with reference to FIGS. 1 and 2 and will therefore not be described again.

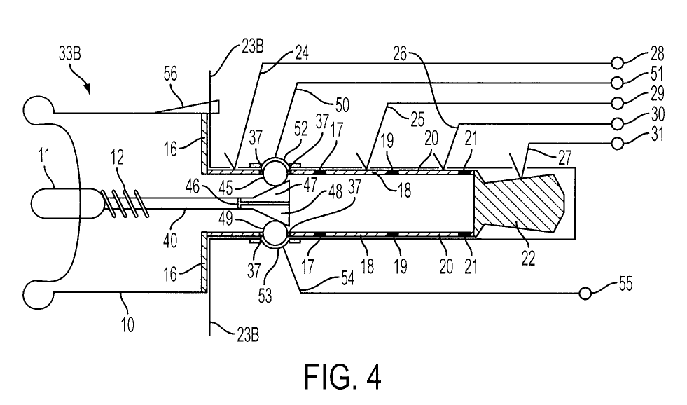

In FIG. 4, a further embodiment of a male connector 33B and a further embodiment of a female connector 23B according to the present invention are described. The embodiments of FIG. 4 are based on the embodiments of FIG. 3, and like elements bear the same reference and will not be described again.

Similar to the embodiment of FIG. 3, in the embodiment of FIG. 4 locking balls 45, 49 are provided which serve as electrical contacts. While in the embodiments of FIG. 3 locking balls 36 serve as a single electric contact, in the embodiment of FIG. 4 locking balls 45, 49 serve as separate electrical contacts. In this embodiment, an end portion of the locking mechanism which is connected with button 11 via a rod 14 is partitioned by an insulation 46 into two electrically conducting regions 47, 48 being insulated from each other, wherein region 47 contacts locking ball 45 and region 48 contacts locking ball 49. In such an embodiment, separate circumferential groove portions 52, 53 for receiving locking balls 45, 49, respectively are provided in female connector 23B. Instead of separate circumferential groove portions, a single circumferential groove with two portions insulated from each other may be provided. Circumferential groove portion 52 is connected via an electrical connection 50 with an electrical contact portion 51, and circumferential groove portion 53 is connected via an electrical connection 54 with a contact portion 55. In male connector 33B, portions 47, 48 are coupled with separate electrical connections like wires (not shown). Therefore, in the embodiment of FIG. 4 through the locking balls 45, 49 two additional electrical contacts are provided in male connector 33B.

In the embodiment of FIG. 4, furthermore a ridge 56 is provided on head 10 which may engage with a corresponding nut (not shown) in female connector 23B. Using ridge 56, a fixed orientation between male connector 33B and female connector 23B may be established such that each locking ball comes in contact with a circumferential groove portion assigned to this locking ball.

Otherwise, the functioning of the embodiments of FIG. 4, in particular as regards the locking mechanism, is the same as already described previously and will not be described again.

The embodiments described above with reference to FIGS. 1-4 serve only as examples, and in other embodiments numerous modifications and variants may be performed. For example, while in male connector 33B of FIG. 4 two locking balls are shown serving as two separate electrical contacts, more than two locking balls serving as separate electrical contacts may be provided. In another embodiment, more than two locking balls may be provided, where for example with four locking balls, two locking balls are assigned to the same electrical contact. In another embodiment, one or more locking balls may be used as electrical contacts as in FIG. 3 or FIG. 4, while other locking balls are not used as electrical contacts like in the embodiment of FIGS. 1 and 2.

The locking mechanism shown in FIGS. 1-4 also may be modified. For example, end portion 14 in FIGS. 1 and 2 may have a different shape, or the direction of movement and the direction of the slope of the slanted sidewalls of end portion 14 may be reversed. In another embodiment, a lever mechanism may be used to eject and retract the locking balls.

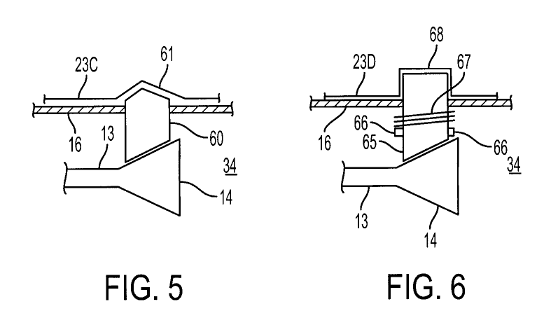

Moreover, while locking balls have been described as locking elements with respect to FIGS. 1-4, other forms of locking elements may also be used, some of which will be described with reference to FIGS. 5 and 6.

FIGS. 5 and 6 each show a partial cross sectional view of a male connector according to another embodiment and a female connector according to another embodiment, wherein compared with the embodiment of FIGS. 1 and 2 the locking balls have been replaced with one or more different elements and the circumferential groove of the female connector has been adapted accordingly. Otherwise, the embodiments of FIGS. 5 and 6 correspond to the embodiments of FIGS. 1 and 2 and therefore, only the above-mentioned locking elements and circumferential groove will be described in detail in the following.

In the embodiments shown in FIG. 5, one or more locking elements 60 are provided which have a generally cylindrical shape, a slanted face adjacent to end portion 14 and a triangular cross section on the side facing female connector 23. Correspondingly, the circumferential groove 61 of the embodiments of FIG. 5 also has a triangular cross section. Also with such a triangular cross section, when end portion 14 is moved to the right in FIG. 5, for example by pressing a corresponding button 11, locking element 60 may retract into elongate member 34 and, when the male connector is pulled from the female connector, locking element 60 is pushed into elongate member 34 by the form circumferential groove 61 and locking element 60.

In FIG. 6, still further embodiments of a male connector and a corresponding female connector are shown. In the embodiment of FIG. 6, a locking element 65 is provided having a generally cylindrically shape with a slanted face facing end portion 14. On the side facing female connector 23, locking element 64 has a rectangular cross section. Correspondingly, in female connector 23B a circumferential groove 68 is provided having a rectangular cross section. Furthermore, a circumferential protrusion 66 is provided on locking element 65, and a spring 67 is provided between circumferential protrusion 66 and portion 16 biasing locking element 65 in FIG. 6 downwards, i.e. into elongate member 54. Therefore, in the embodiment of FIG. 6 when end portion 14 is moved to the right for example by pushing a corresponding button 11, locking element 65 is moved by the biasing force of spring 67 to retract into elongate member 34.

It should be noted that a biasing mechanism comprising protrusions like circumferential protrusion 66 and a resilient element like spring 67 may also be used with other forms of locking elements, for example with locking element 60 of FIG. 5 or also with locking balls as in the embodiments of FIGS. 1-4. Instead of springs like spring 12 or spring 67, other resilient elements like rubber elements may be used. Moreover, it has to be understood that in FIGS. 5 and 6, one locking element 60, 65, respectively, has been shown for simplifying the illustration, but more than one locking element may be provided. While in the embodiment of FIGS. 1-4 TRRS type audio connectors are shown, a locking mechanism as described may be used with any connector having an elongate member like elongate member 34. For example, other kinds of audio connectors having less contacts, for example TRS connectors or TS connectors which have only one or no ring portion in contrast to two ring portions 18, 20 in the embodiment of FIGS. 1-4 may be used. Also, as audio connectors, 2.5 mm audio connectors, 3.5 mm audio connectors or any other type of audio connector may be used. In an embodiment, the male connector part may be coupled to a neck strap and a head set, and the female connector part may be part of a portable audio device (or vice versa) to enable a user to wear the device when the connectors are coupled and secured by the locking mechanism.

Therefore, numerous modifications and variants are accessible to persons skilled in the art, and the scope of the present invention is intended to be defined only by the appended claims and equivalents thereof.

1-15. (canceled)

16. A connector comprising:
an elongate member including at least two electrically conducting areas on an outer surface thereof, the at least two electrically conducting areas being electrically insulated from each other,
at least one locking element that is displaceable between a first position retracted into the elongate member and a second position protruding from a circumferential surface of the elongate member, and
an ejection mechanism configured to displace the at least one locking element from the first position to the second position.

17. The connector of claim 16, wherein the connector comprises an audio connector.

18. The connector of claim 17, wherein the audio connector comprises at least one of a 2.5 mm audio connector or a 3.5 mm audio connector.

19. The connector of claim 16, wherein the ejection mechanism comprises an ejection element having a slanted surface in contact with the at least one locking element, the ejection element being displaceable to displace the at least one locking element from the first position to the second position.

20. The connector of claim 19, wherein the ejection element is coupled with a resilient element, the resilient element to bias the ejection element to a position corresponding to the second position of the at least one locking element.

21. The connector of claim 20, further comprising:
a button coupled with the ejection element for displacing the ejection element against a biasing force of the resilient element.

22. The connector of claim 20, wherein the resilient element comprises a spring.

23. The connector of claim 16, wherein the at least one locking element comprises at least one locking ball.

24. The connector of claim 16, wherein the at least one locking element is coupled with a resilient element, the resilient element biasing the at least one locking element to the first position.

25. The connector according to claim 16, wherein the at least one locking element is electrically conducting, the at least one locking element being electrically insulated from the at least two electrically conducting areas.

26. The connector of claim 25, wherein the at least one locking element comprises at least two locking elements, each of the at least two locking elements being electrically conducting and being electrically insulated from each other to form separate electrical contact areas.

27. The connector of claim 26, wherein the ejection mechanism comprises, for each of the at least two locking elements, a contact portion, the contact portions being electrically insulated from each other.

28. The connector of claim 27, further comprising:
a ridge arranged at a side of the connector.

29. A connector comprising:
an elongate hole,
at least two contact elements configured to contact different portions of a male connector configured to mate in the elongate hole, and
at least one circumferential groove portion in a sidewall of the elongate hole.

30. The connector of claim 27, wherein the at least one groove portion is electrically conducting and insulated from the contacts.
